(19) United States
(12) Patent Application Publication
(10) Pub. No.: US 2025/0288148 A1
(43) Pub. Date: Sep. 18, 2025

(54) Drip Coffee Machine with Electric Water Level Sensor

(71) Applicant: IB APPLIANCES US HOLDINGS LLC, Downers Grove, IL (US)

(72) Inventors: Yude HAN, Downers Grove, IL (US); Daniel M. WODKA, Downers Grove, IL (US); Wenyong ZHU, Downers Grove, IL (US); Jinju DING, Downers Grove, IL (US)

(73) Assignee: IB APPLIANCES US HOLDINGS LLC, Downers Grove, IL (US)

(21) Appl. No.: 18/861,476

(22) PCT Filed: Jan. 9, 2023
(86) PCT No.: PCT/CN2023/071162

§ 371 Date: Oct. 29, 2024

(51) Int. Cl. A47J 31/52; A47J 31/057; A47J 31/44; A47J 31/46; A47J 31/54; A47J 31/56; G01F 23/24

(52) U.S. Cl. CPC A47J 31/525; A47J 31/0573; A47J 31/4457; A47J 31/469; A47J 31/545; A47J 31/56; G01F 23/241; A47J 2203/00

(57) ABSTRACT

One form of a drip coffee machine comprises a water level sensor, a boiler, and a processor. The water level sensor is positioned within the drip coffee machine at a junction where a water tank connects to the drip coffee machine. The water level sensor comprises a pair of electrodes positioned within an interior region, wherein a resistance between the pair of electrodes indicates whether water is present in the water tank. The boiler comprises a heating element that is configured to heat water within the boiler. The processor is in communication with the water level sensor and the boiler, and is configured to turn on the heating element of the boiler and to turn off the heating element of the boiler based in part on the resistance between the pair of electrodes of the water level sensor.

### RELATED APPLICATION

This is a national stage application of International Patent Application No. PCT/CN2023/071162, filed on Jan. 9, 2023, pending, the entirety of which is herein incorporated by reference.

### BACKGROUND

Conventional drip coffee machines include elements such as heated tubes that warm water as the water passes through the tubes for application over ground coffee beans. Such conventional drip coffee machines are typically characterized by a brewing cycle that runs constantly, until a water tank is completely emptied. Typically, conventional drip coffee machines also utilize thermal probes for determining when water is no longer present in the drip coffee machine, based on a temperature of the heated tubes. Generally, a temperature of the heated tubes significantly increases when water is no longer present in the machine, thereby signaling the absence of water. This increased temperature of the heated tubes may result in the heated tubes generating undesirable steam and pressure within the system that may damage elements of the drip coffee machine, as well as create undesirable noises and external bursts of steam that may concern a user.

In contrast to conventional drip coffee machines, “pod-style” single-serve coffee machines meter out limited volumes of water (e.g., 8, 10, or 12 ounces at a time), and do not utilize a brewing cycle that runs constantly, until a water tank is completely emptied. Such single-serve coffee machines, therefore, do not typically present the same steam, pressure, and noise issues of a conventional drip coffee machine

### SUMMARY

When different types of heating sources are utilized within a drip coffee machine, the potential for undesirable steam, pressure, and noise may increase significantly. For example, in implementations of a drip coffee machine described in the present disclosure, a high-wattage boiler is utilized to quickly warm a relatively large volume of water (as compared to the heated tubes of conventional drip coffee machines) to rapidly brew a pot of coffee. However, use of a high-powered boiler in a drip coffee machine may also produce a large amount of undesirable steam, pressure, and noise, near the end of a brewing cycle, when water is no longer present within the boiler, in particular, as a water tank of the drip coffee machine runs out of water.

Accordingly, it is desirable for a drip coffee machine to have the ability to accurately determine a water level within a drip coffee machine, and quickly reduce a possibility of the drip coffee machine generating undesirable steam, pressure, and/or noises when water is not present in the system, and/or when water levels are nearly diminished. The present disclosure addresses this problem by providing a drip coffee machine with an electric water level sensor.

In one aspect, the present disclosure provides a drip coffee machine comprising a water level sensor, a boiler, and a processor. The water level sensor is positioned within the drip coffee machine at a junction where a water tank connects to the drip coffee machine, the water level sensor defining an interior region configured to receive water flowing from the water tank, the water level sensor comprising a pair of electrodes positioned within the interior region, wherein a resistance between the pair of electrodes indicates whether water is present in the water tank.

The boiler comprises a heating element surrounding at least a portion of an exterior of the boiler, where the boiler is configured to receive water flowing from the water level sensor and to heat the received water with the heating element.

The processor is in communication with the water level sensor and the boiler. The processor is configured to turn on the heating element of the boiler and to turn off the heating element of the boiler based in part on the resistance between the pair of electrodes of the water level sensor.

In another aspect, the present disclosure provides another drip coffee machine comprising a water tank connector, a water level sensor, a heat source, and a processor. The water tank connector is configured to couple with a water tank and receive water from the water tank.

The water level sensor is configured to couple with the water tank connector, where the water level sensor defines an interior region configured to receive water flowing from the water tank. The water level sensor comprises a pair of electrodes positioned within the interior region, where a resistance between the pair of electrodes indicates whether water is present in the water tank.

The heat source is configured to receive water flowing from the water level sensor and to heat the received water. The processor is in communication with the water level sensor and the heat source, and is configured to turn on the heat source and to turn off the heat source based in part on the resistance between the pair of electrodes of the water level sensor, wherein the processor is configured to turn off the heat source and end a brewing cycle when the resistance between the pair of electrodes of the water level sensor indicates that water is not present in the water tank.

In another aspect, the present disclosure provides a method for operating a drip coffee machine. In the method, a processor of the drip coffee machine measures, during a brewing cycle of the drip coffee machine, a resistance between two electrodes of a water level sensor positioned at a junction where a water tank connects to the drip coffee machine, where the resistance between the two electrodes of the water level sensor indicates whether water is present in the water tank.

The processor determines, based on the measured resistance between the two electrodes of the water level sensor that water is not present in the water tank during the brewing cycle. Further, the processor turns off a heating source of the drip coffee machine based on the determination that water is not present in the water tank during the brewing cycle, the heating source configured to heat water from the water tank.

### BRIEF DESCRIPTION OF THE DRAWINGS

Embodiments and implementations of the present disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 is a perspective view of an exterior of one form of a drip coffee machine.

FIG. 2 is a first side view of interior elements of one form of a drip coffee machine.

FIG. 3 is a second side view of interior elements of one form of a drip coffee machine.

FIG. 4 is a perspective view of interior elements of one form of a drip coffee machine.

FIG. 5 is a first side view of interior elements of one form of a drip coffee machine with a water tank removed

FIG. 6 is a second side view of interior elements of one form of a drip coffee machine with a water tank removed.

FIG. 7 is a rear view of interior elements of one form of a drip coffee machine with a water tank removed

FIG. 8 is a top view of one form of an electric water level sensor.

FIG. 9 is a perspective view of one form of an electric water level sensor.

FIG. 10 is a front view of one form of a boiler of a drip coffee machine.

FIG. 11 is a cross-sectional view of the boiler of FIG. 10.

FIG. 12 is a flow chart of one form of a method for operating a drip coffee machine including a water level sensor and a heating source such as a boiler.

### DETAILED DESCRIPTION

The present disclosure provides a drip coffee machine with a heating source such as a boiler and an electric water level sensor. A drip coffee machine may utilize a boiler to heat a large volume of water in a short period of time. As a result, the drip coffee machine is able to quickly brew a pot of coffee when compared to conventional drip coffee machines that utilize heating tubes to heat water. However, use of a boiler, especially a high-powered boiler, in drip coffee machines may also produce a large amount of undesirable steam, pressure, and/or noise near the end of a brewing cycle, when water is no longer present within the boiler, particularly as a water tank of the drip coffee machine runs out of water.

To address these issues, an electric water level sensor is positioned at a junction of a water tank with the drip coffee machine to more accurately determine when water is no longer present in the water tank. As a result, the drip coffee machine is able to quickly turn off a heating element of the boiler before excess steam and pressure is generated within brewing elements of the drip coffee machine. Preventing excess steam and pressure within brewing elements of the drip coffee machine reduces the possibility of damaging brewing elements of the drip coffee machine, and reduces the potential for external bursts of steam and/or noises emanating from the drip coffee machine that may cause a user concern.

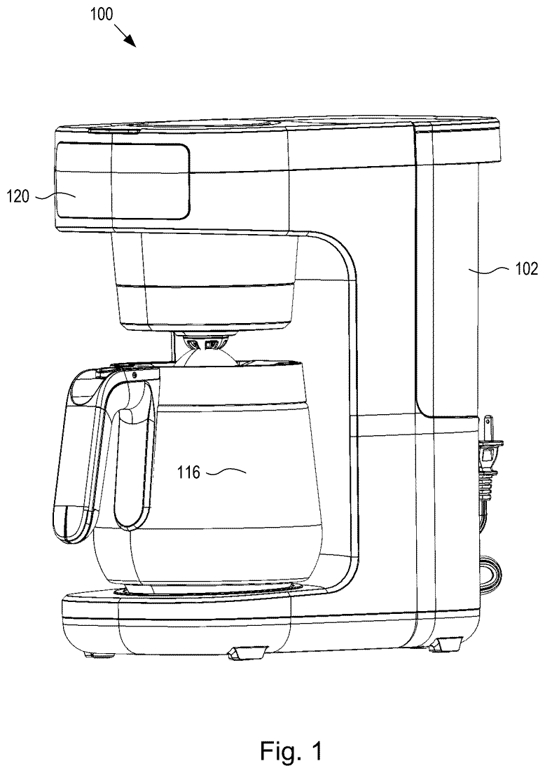

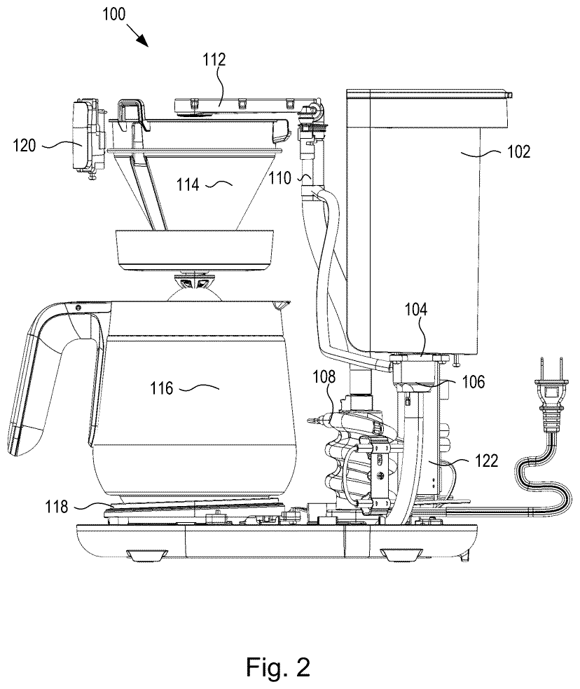

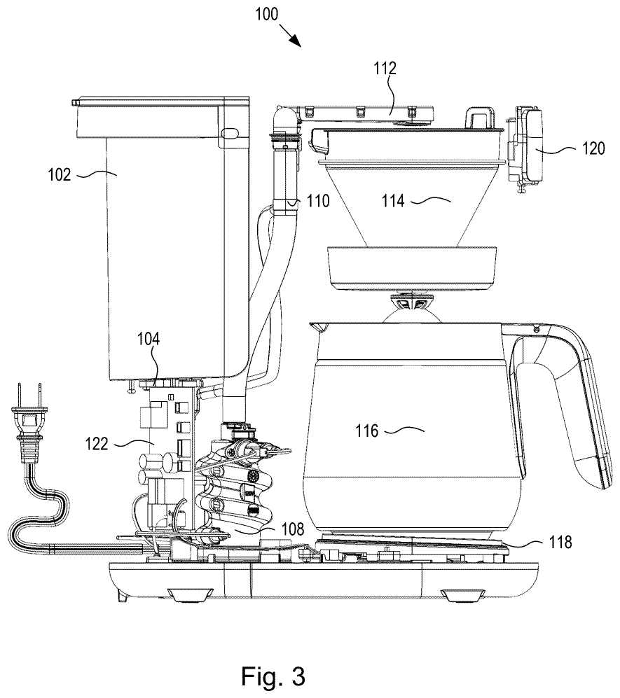

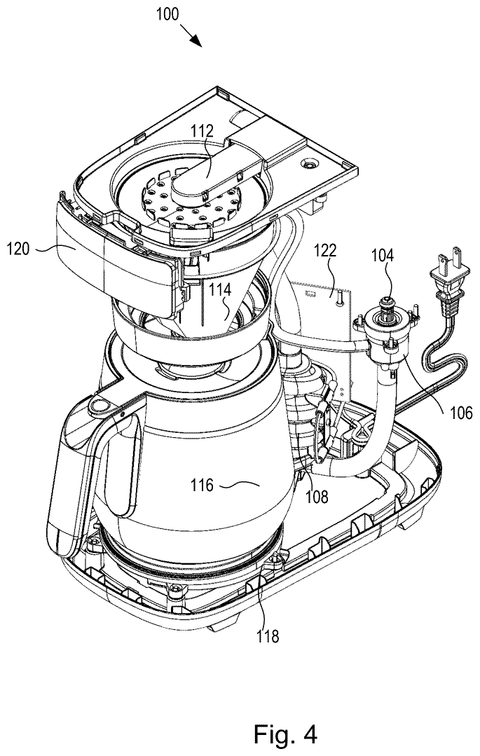

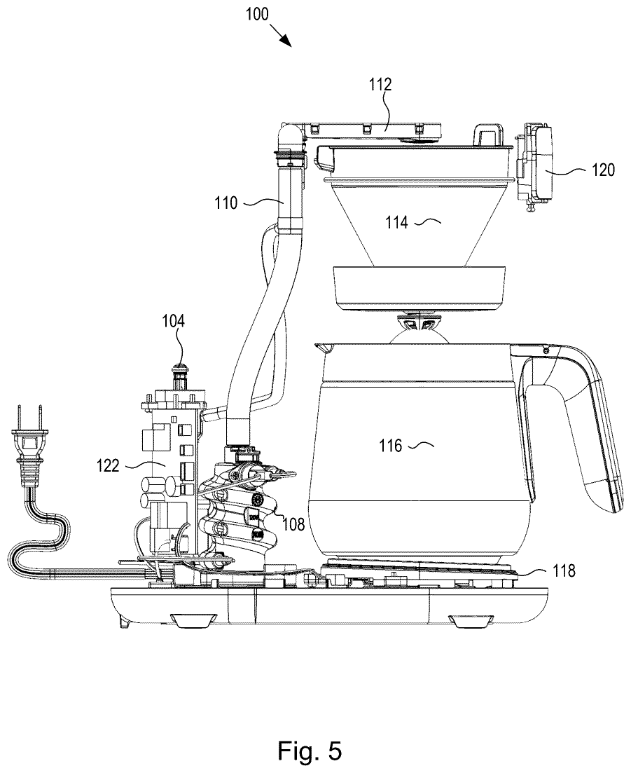

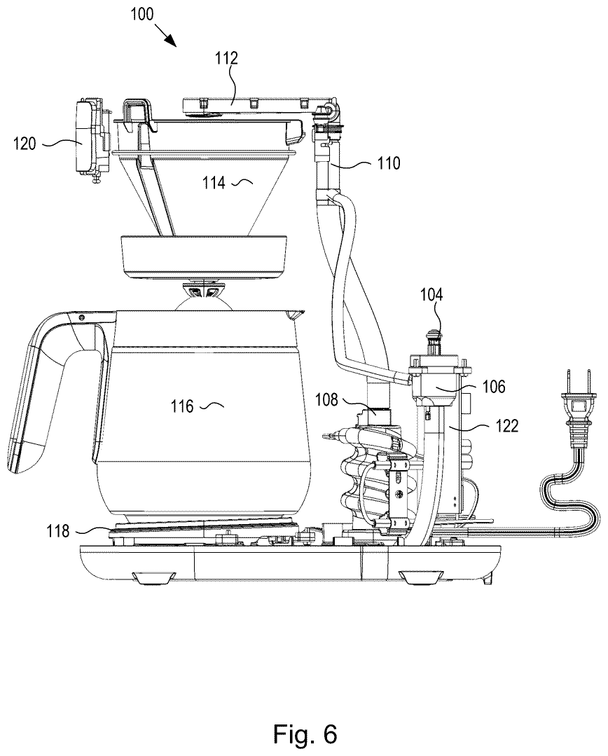

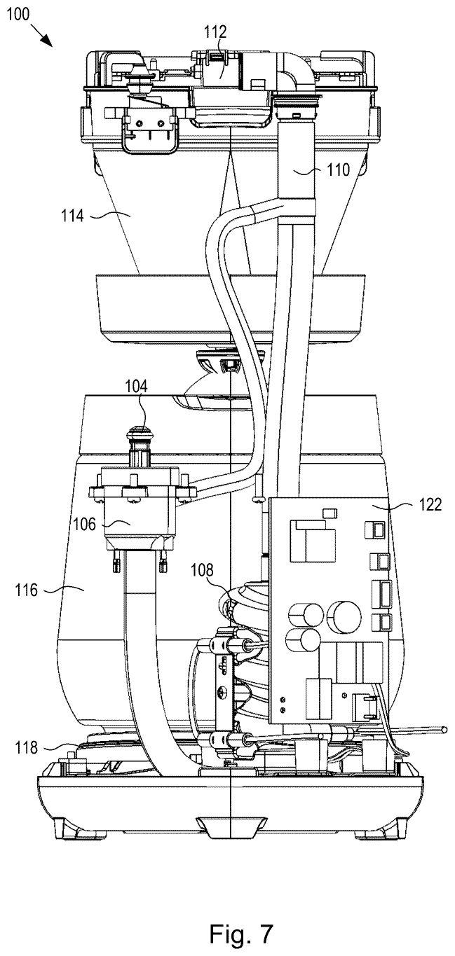

FIG. 1 is a perspective view of an exterior of one form of a drip coffee machine; FIGS. 2 and 3 are first and second side views of interior elements of one form of a drip coffee machine connected to water tank; and FIGS. 4-7 are various views of interior elements of one form of a drip coffee machine that is not connected to a water tank.

Implementations of a drip coffee machine 100 may include a water tank 102, a water tank connector 104, a water level sensor 106, a boiler 108, a three-way connector 110, a water dispenser 112, a funnel 114, a carafe 116, a warmer plate 118, a control panel/display 120, and a printed circuit board 122 including at least a processor, a controller, or other processing circuitry, collectively referred to as a processor below, and memory. In some implementations, the processor is configured to execute instructions stored in the memory to perform operations as described in the present disclosure.

As will be explained in more detail below, during operation, when a water tank 102 holding water is connected to the water tank connector 104, water flows from the water tank 102, through the water tank connector 104, and into the water level sensor 106. As the water level sensor 106 detects water, the water level sensor 106 indicates to the processor of the printed circuit board 122 that water is present in the water tank 102. As a result, the processor allows the user to initiate a brewing cycle, which typically runs continuously until water is no longer present in the water tank 102.

When a user initiates a brewing cycle by interacting with the control panel/display 118, water flows from water tank 102 to the boiler 108 by way of the water tank connector 104, the water level sensor 106, and tubing connecting the water level sensor 106 and the boiler 108. When the user initiates the brewing cycle, the processor turns on the boiler 108 to heat water as it flows into the boiler 108.

The heated water flows from the boiler 108 to the three-way connector 110 through tubing and is directed into the water dispenser 112. In some implementations, the water dispenser 112 may be a shower head, an outlet of a tube, or a nozzle, for example. The heated water flows from the water dispenser 112 and into coffee grounds positioned in the funnel 114. As coffee exits the funnel 114, it is directed into the carafe 116, where the warmer plate 118 may warm the coffee within the carafe 116.

During a brewing cycle, the water level sensor 106 coupled with the water tank connector 104 indicates whether water is present in the water tank 102. In some implementations, the water level sensor 106 is positioned in the brewing path within the drip coffee machine 100 at a height above that of the boiler 108. In such implementations, this spatial separation between the water level sensor 106 and the boiler 108 ensures that a residual amount of water in the path between the water level sensor 106 and the boiler 108 may be feed to the boiler 108, as it cools down, and after it is deactivated or powered down.

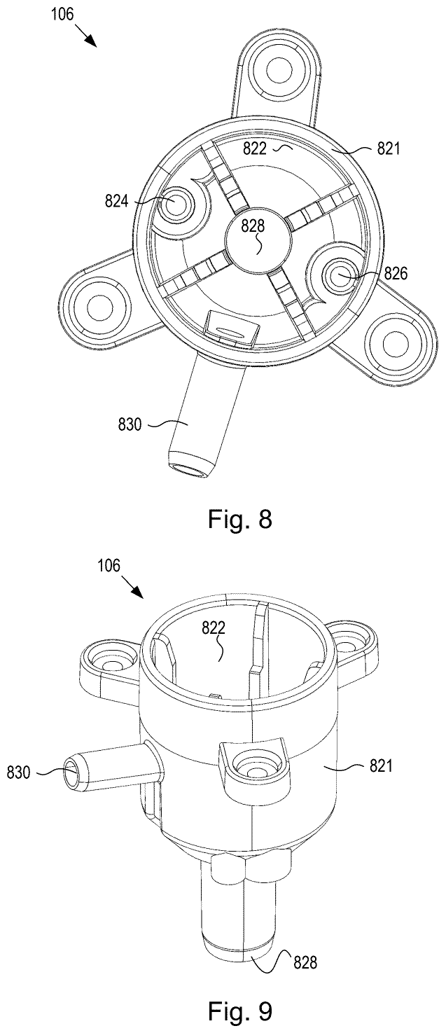

FIG. 8 is a top view of one form of a water level sensor 106 and FIG. 9 is a perspective view of one form of a water level sensor 106. The water level sensor 106 includes a body 821 that defines an interior region 822 that water from the water tank 102 may flow into via the water tank connector 104. The water level sensor 106 includes a pair of electrodes such as a first electrode 824 and a second electrode 826 positioned within the interior region 822 of the water level sensor 106. The water level sensor 106 additionally defines an aperture 828 at a bottom of the interior region 822 to provide a path for the water leaving the water tank 102 to flow through tubing to the boiler 108. In some implementations, the first and second electrodes 824, 826 are positioned on opposite sides of the aperture 828 where water flows from the interior region 822 of the water level sensor 106.

During operation, an amount of resistance is measured between the first electrode 824 and the second electrode 826. When water from the water tank 102 is present in the interior of the water level sensor 822, a resistance level measured between the first and second electrodes 824, 826 is low and current may flow between the two electrodes. However, when water from the water tank 102 is not present in the interior of the water level sensor 822, a resistance level measured between the first and second electrodes 824, 826 is high and current may not flow between the two electrodes.

As a result, when water from the water tank 102 is present in the interior region 822, a first level of current flows between the first electrode 824 and the second electrode 826 and the water level sensor 106 indicates that water is present in the water tank 102. Alternatively, when water from the water tank 102 is not present in the interior region 822, a second level of current flows between the first electrode 824 and the second electrode 826 and the water level sensor 106 indicates that water is not present in the water tank 102.

It will be appreciated that because the water level sensor 106 is positioned at the junction of the water tank 102 and the water tank connector 104 rather than downstream in the brewing path, the water level sensor 106 is able to accurately detect whether water is present in the water tank 102. It will also be appreciated that in implementations of a drip coffee maker 100 where the water tank 102 is not removable from the drip coffee machine, the water level sensor 106 may still be positioned at the junction of the water tank 102 and brewing elements of the drip coffee maker 100, or even be positioned in a lower portion of the water tank 102 itself, to accurately detect whether water is present in the water tank 102.

In some implementations, the water level sensor 106 may utilize circuitry such that when water is present in the interior region 822 of the water level sensor 106, current flows between the first and second electrodes 824, 826 such that the electrodes act as a closed circuit, resulting in the circuitry outputting a first value, such as +5 volts. However, when water is not present in the interior region 822 of the water level sensor 106, current is generally prevented from flowing between the first and second electrodes 824, 826 such that the electrodes act as an open circuit, resulting in the circuitry outputting a second value, such as 0 volts. Accordingly, the processor will know whether or not water is present in the water tank 102 based on the voltage output by the circuitry of the water level sensor 102. In some implementations, this circuitry may be positioned on the printed circuit board 122 and in communication with the first and second electrodes 824, 826 positioned within the interior region 822 of the water level sensor 106.

In other implementations, the processor may operate in conjunction with the water level sensor 106 to determine whether water is present in the water tank 102 by measuring a resistance between the two electrodes 824, 826 of the water level sensor 106 and comparing the measured resistance to a threshold. In some implementations, when the measured resistance exceeds the threshold, the water level sensor 106 indicates that water is not present in the water tank 102. Alternatively, when the measured resistance does not exceed the threshold, the water level sensor 106 indicates that water is present in the water tank 102. It will be appreciated that any threshold may be used that accurately indicates whether or not water is present in the interior region 822 of the water level sensor 106, thereby also indicating whether water is present in the water tank 102.

In some implementations, the water level sensor 106 may include one or more venting tubes 830 that vent air bubbles that enter the interior region 822 from the water tank 102. Air bubbles may interfere with measuring a resistance between the electrodes 824, 826 and cause the water level sensor 106 to provide a false-positive that the water tank 102 is empty. In some implementations, the venting tubes 830 may include a first tube positioned above the first electrode 824 and a second tube positioned above the second electrode 826 to better vent water bubbles from around the electrodes.

In some implementations, the venting tubes 830 lead from the water level sensor 106 to the three-way connector 110, as explained below. However, in other implementations the venting tubes 830 may vent the air bubbles to ambient air. In these implementations, an end of the venting tubes 830 that lead to ambient air are positioned above a water level of the water tank 102 so that water does not flow out of the venting tubes 830.

In some implementations, a shape of the water level sensor 106, alone or when coupled with the water tank connector 104, act to direct air bubbles within the interior region 822 of the water level sensor 106 back up into the water tank 102 via the water tank connector 104. For example, a shape of a top of the interior region 822 formed the water level sensor 106 coupled with the water tank connector 104 may be slanted to encourage air bubbles to move towards the water tank 102.

Referring again to FIGS. 2-7, water from the water tank 102 flows to the boiler 108 by way of the water tank connector 104 and the water level sensor 106. When a user initiates a brewing cycle and the water level sensor 106 indicates that water is present in the water tank 102, the processor of the printed circuit board 122 initiates heating of the boiler 108. It will be appreciated that in the alternative, when a user attempts to initiate a brewing cycle and the water level sensor 106 indicates that water is not present in the water tank 102, the processor of the printed circuit board 122 will prevent initiation of a brewing cycle and does not initiate heating of the boiler 108.

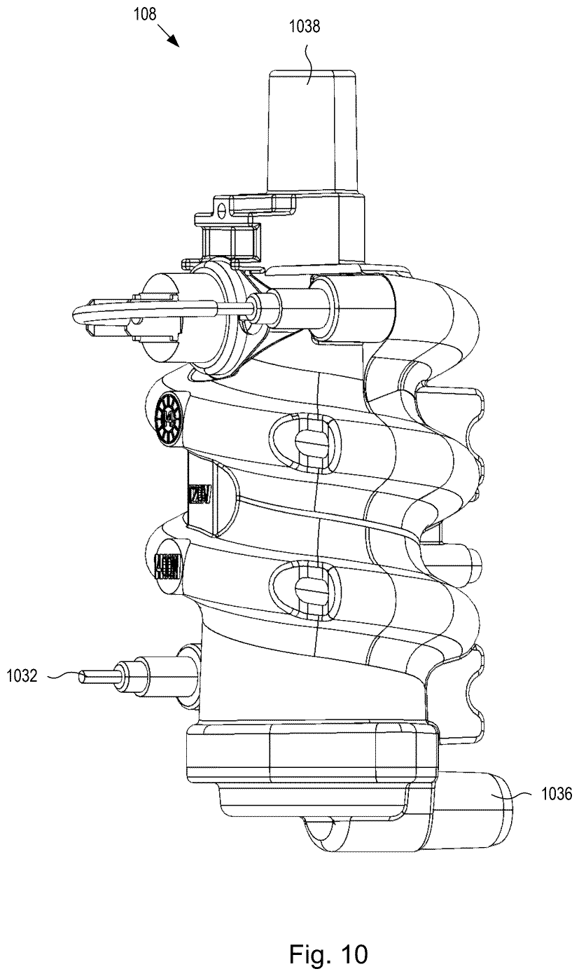

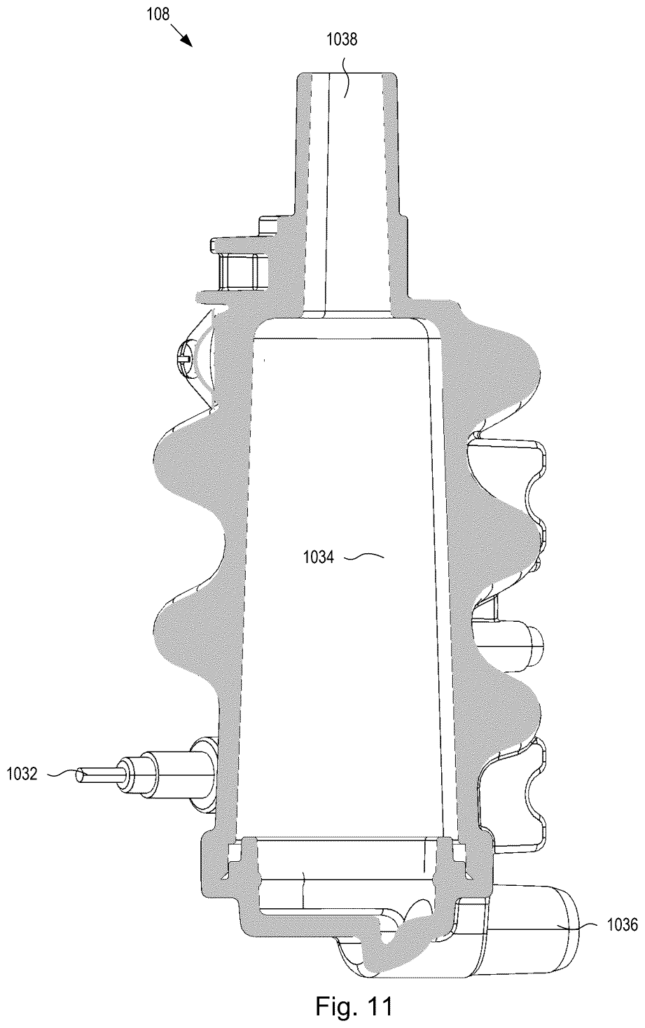

FIG. 10 is a front view of one form of a boiler 108 of a drip coffee machine 100 and FIG. 11 is a cross-sectional view of the boiler of FIG. 10. As shown in FIGS. 10 and 11, in some implementations, the boiler 108 includes heating elements 1032, such as resistive wire, that at least partially surround an exterior of the boiler 108 to heat water within an interior cavity 1034 the boiler 108. During a brewing cycle, water flows into the interior cavity 1034 from a bottom aperture 1036 positioned at a bottom of the interior cavity 1034. As water is heated within the interior cavity 1034 of the boiler, the water percolates, rises, and exits the interior cavity 1034 at a top aperture 1038 positioned at a top of the interior cavity 1034.

In some implementations, the boiler 108 may be a high-powered 1400-watt boiler, where the interior cavity 1034 is cylindrical in shape and holds approximately two to three ounces of water. However, in other implementations, boilers of different wattages with an interior cavity 1034 having other shapes and/or holding different volumes of water may be used.

Typically, once heating elements 1032 of a boiler 108 such as those described above are turned on, the boiler 108 may heat a large enough volume of water in a drip coffee machine 100 to start dispensing brewed coffee into the carafe 116 within 15-30 seconds. Additionally, once heating elements 1032 of a boiler 108 such as those described above are turned off, the boiler 108 may cool down enough to stop producing unwanted steam and/or pressure within the drip coffee machine 100 within seconds.

The processor of the printed circuit board 122 may turn off the heating elements 1032 of the boiler 108 when the brewing cycle is complete to prevent the generation of steam and pressure within the elements of the drip coffee machine 100. Similarly, during a brewing cycle, if the water level sensor 106 indicates that water is not present in the water tank 102, the processor of the printed circuit board 122 may turn off the heating elements 1032 of the boiler 108 and end the brewing cycle ends to prevent the generation of steam and pressure within the elements of the drip coffee machine 100.

In some implementations, the processor of the printed circuit board 122 may turn off the heating elements 1032 of the boiler 108 immediately when the water level sensor 106 indicates that water is not present in the water tank 102. However, in other implementations, the processor of the printed circuit board 122 may delay turning off the heating elements 1032 of the boiler 108 when the water level sensor 106 indicates that water is not present in the water tank 102. In these implementations, the processor of the printed circuit board 122 may delay turning off the heating elements 1032 of the boiler 108 based on amount of water that is known to be present in the brewing path between the water level sensor 106 and the boiler 108.

Referring again to FIGS. 1-7, as heated water leaves the boiler 108, it flows to the three-way connector 110 via tubing. The three-way connector 108 connects tubing from the boiler 108 and venting tubing 830 from the water level sensor 106 with tubing leading to the water dispenser 112. Accordingly, heated water from the boiler 108 and any water and/or air bubbles from the water level sensor 106 is directed to the water dispenser 112 where the water is directed into coffee grounds positioned in the funnel 114.

As the water passes through the coffee grounds, coffee exits the funnel 114 and is directed into the carafe 116, where the warmer plate 118 may warm the coffee within the carafe 116. In some implementations, the warmer plate is controlled by the processor of the printed circuit board 118 to turn on immediately after the brewing cycle is initiated, at the end of a brewing cycle, a period of time after the end of a brewing cycle, when the water level sensor 106 indicates that water is not present in the water tank 102 during a brewing cycle, or when a user interacts with the control panel/display 120 to turn on the warming plate 118, for example.

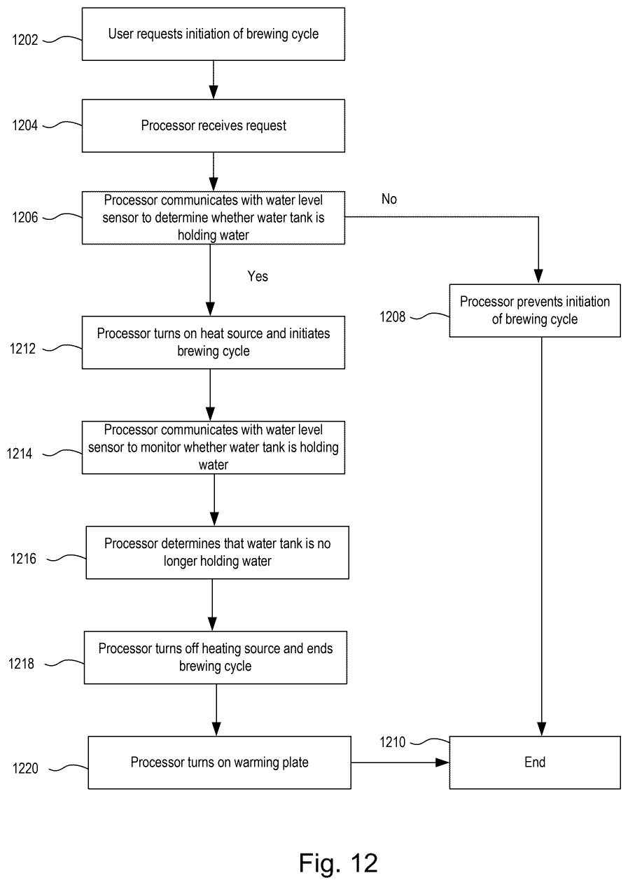

FIG. 12 is a flow chart of one form of a method for operating a drip coffee machine such as those described above that includes a water level sensor and a heating source such as a boiler.

At step 1202, a user interacts with a control panel/display of a drip coffee machine to request initiation of a brewing cycle.

At step 1204, a processor of the drip coffee machine that is in communication with the control panel/display receives the request.

At step 1206, the processor communicates with a water level sensor positioned at a junction where a water tank connects to the drip coffee machine to determine whether water is present in the water tank. As described above, in some implementations, this may include the processor measuring a resistance between two electrodes of the water level sensor and comparing the measured resistance to a threshold to determine whether water is present in the water tank. In other implementations, this may include the processor measuring a voltage output by the water level sensor where the water level sensor outputs a first voltage when water is present in the water tank and outputs a second voltage when water is not present in the water tank.

When the processor determines at step 1206 that water is not present in the water tank, at step 1208 the processor prevents the drip coffee machine from initiating a brewing cycle and the method ends 1210.

When the processor determines at step 1206 that water is present in the water tank, at step 1212, the processor turns on the heat source, such as turning on a heating element of a boiler, and initiates the brewing cycle. As previously mentioned, in some embodiments, the brewing cycle may be configured to run until the water tank is emptied. In other embodiments, the brewing cycle may be configured to run for a set amount of time, or to brew a set volume of coffee, so as to brew a volume of coffee less than the total volume of water in the water tank. In some embodiments, a user may selectively control whether the brewing cycle runs until the water tank is emptied, or for some set amount of time, or for some set volume of coffee.

During the brewing cycle, at step 1214, the processor communicates with the water level sensor to monitor whether water is present in the water tank. As described above, in some implementations, this may include the processor measuring a resistance between two electrodes of the water level sensor and comparing the measured resistance to a threshold to determine whether water is present in the water tank. In other implementations, this may include the processor measuring a voltage output by the water level sensor where the water level sensor output a first voltage when water is present in the water tank and outputs a second voltage when water is not present in the water tank.

At step 1216, the processor determines, based on information from the water level sensor, that water is not present in the water tank during the brewing cycle. In response, at step 1218, the processor turns off the heating source of the drip coffee machine, such as turning off heating elements of a boiler, and ends the brewing cycle.

In some implementations, at step 1220, the processor may perform additional functions after turning off heat source, such as turning on a warming plate of the drip coffee machine to warm a carafe of coffee, before the method ends at step 1210.

As discussed above in conjunction with FIGS. 1-12, the present disclosure provides a drip coffee machine with an electric water level sensor. The electric water level sensor may be positioned at a junction of a water tank with the drip coffee machine to accurately determine when water is no longer present in the water tank. Based on indications from the water level sensor, the drip coffee machine is able to turn off a heating source of the drip coffee machine, such as a heating element of a boiler and end a brewing cycle before excess steam, pressure, and/or noise is generated within brewing elements of the drip coffee machine. Preventing excess steam and pressure within brewing elements of the drip coffee machine protects the brewing elements of the drip coffee machine from damage, Likewise, preventing the potential for external bursts of steam and/or noises emanating from the drip coffee machine may improve user experience.

The foregoing disclosure has been set forth to illustrate the invention and is not intended to be limiting. Since modifications of the disclosed form and implementations incorporating the spirit and substance of the invention may occur to persons skilled in the art, the invention should be construed to include everything within the scope of the appended claims and equivalents thereof.

1. A drip coffee machine comprising:
a water level sensor positioned within the drip coffee machine at a junction where a water tank connects to the drip coffee machine, the water level sensor defining an interior region configured to receive water flowing from the water tank, the water level sensor comprising a pair of electrodes positioned within the interior region, wherein a resistance between the pair of electrodes indicates whether water is present in the water tank;
a boiler comprising a heating element surrounding at least a portion of an exterior of the boiler, the boiler configured to receive water flowing from the water level sensor and to heat the received water with the heating element; and
a processor in communication with the water level sensor and the boiler, the processor configured to turn on the heating element of the boiler and to turn off the heating element of the boiler based in part on the resistance between the pair of electrodes of the water level sensor.

2. The drip coffee machine of claim 1, wherein the water tank is fixed to the drip coffee machine.

3. The drip coffee machine of claim 1, wherein:
the water tank is removable from the drip coffee machine; and
the drip coffee machine further comprises a water tank connector configured to couple with the water tank and receive water from the water tank; and
the water level sensor is in communication with the water tank connector.

4. The drip coffee maker of claim 1, wherein the processor is configured to allow the boiler to run continuously and heat water during a brewing cycle until water is no longer present in the water tank.

5. The drip coffee maker of claim 1, wherein the water level sensor comprises circuitry configured to:
output a first voltage when a first level of resistance is present between the first electrode and the second electrode, thereby indicating that water is present in the water tank; and
output a second voltage when a second level of resistance is present between the first electrode and the second electrode, thereby indicating that water is not present in the water tank.

6. The drip coffee maker of claim 1, wherein the processor is configured to:
measure an amount of resistance between the two electrodes;
compare the measured amount of resistance to a threshold; and
determine whether water is present in the water tank based on whether the measured amount of resistance exceeds the threshold.

7. The drip coffee maker of claim 6, wherein the processor is configured to prevent initiation of a brewing cycle of the drip coffee machine upon a determination that water is not present in the water tank.

8. The drip coffee maker of claim 6, wherein the processor is configurated to turn on the heating element of the boiler upon a determination that water is present in the water tank and an initiation of a brewing cycle.

9. The drip coffee maker of claim 6, wherein the processor is configured to turn off the heating element of the boiler upon a determination that water is not present in the water tank during a brewing cycle.

10. The drip coffee maker of claim 1, wherein the water level sensor further comprises tubing in communication with the interior region of the water level sensor that is configured to vent air from the interior region of the water level sensor.

11. The drip coffee maker of claim 10, wherein the tubing comprises a first tube positioned above the first electrode and a second tube positioned above the second electrode.

12. The drip coffee maker of claim 10, wherein the tubing vents into a brewing path of the drip coffee machine.

13. The drip coffee maker of claim 12, further comprising:
a water dispenser configured to receive water that has been heated by the boiler and to direct the water to flow over ground coffee beans positioned in the drip coffee machine; and
a three-way connector configured to receive water from the boiler, to receive at least one of air or water from the tubing of the water level sensor, and to direct water to the water dispenser.

14. A drip coffee machine comprising:
a water tank connector configured to couple with a water tank and receive water from the water tank;
a water level sensor configured to couple with the water tank connector, the water level sensor defining an interior region configured to receive water flowing from the water tank, the water level sensor comprising a pair of electrodes positioned within the interior region, wherein a resistance between the pair of electrodes indicates whether water is present in the water tank;
a heat source configured to receive water flowing from the water level sensor and to heat the received water; and
a processor in communication with the water level sensor and the heat source, the processor configured to turn on the heat source and to turn off the heat source based in part on the resistance between the pair of electrodes of the water level sensor, wherein the processor is configured to turn off the heat source and end a brewing cycle when the resistance between the pair of electrodes of the water level sensor indicates that water is not present in the water tank.

15. The drip coffee machine of claim 14, wherein:
the heat source is a boiler comprising a heating element surrounding at least a portion of an exterior of the boiler that is configured to heat water within the boiler; and
during the brewing cycle, the boiler is configured to continuously heat water until the processor turns off the heating element and ends the brewing cycle when the resistance between the pair of electrodes of the water level sensor indicates that water is not present in the water tank.

16. The drip coffee machine of claim 14, wherein the water tank is removable.

17. A method for operating a drip coffee machine, the method comprising:
measuring, with a processor of the drip coffee machine, during a brewing cycle of the drip coffee machine, a resistance between two electrodes of a water level sensor positioned at a junction where a water tank connects to the drip coffee machine, wherein the resistance between the two electrodes of the water level sensor indicates whether water is present in the water tank;
determining, with the processor, based on the measured resistance between the two electrodes of the water level sensor, that water is not present in the water tank during the brewing cycle; and
turning off, with the processor, a heating source of the drip coffee machine based on the determination that water is not present in the water tank during the brewing cycle, the heating source configured to heat water from the water tank.

18. The method of claim 17, wherein:
the heating source is a boiler comprising a heating element at least partially surrounding an exterior of the boiler that is configured to heat water within the boiler;
turning off the heating source comprises turning off, with the processor, the heating element of the boiler; and
the boiler runs continuously to heat water within the boiler during the brewing cycle until the processor turns off the heating source based on the determination that water is no present in the water tank.

19. The method of claim 17, wherein the water tank is removable.

20. The method of claim 17, further comprising:
receiving, with the processor, a request to initiate the brewing cycle;
measuring, with the processor, prior to initiation of the brewing cycle, a resistance between the two electrodes of the water level sensor;
determining, with the processor, prior to initiation of the brewing cycle, based on the measured resistance between the two electrodes of the water level sensor, that water is present in the water tank; and
turning on, with the processor, the heating source of the drip coffee machine and initiating the brewing cycle after determining, prior to initiation of the brewing cycle, that water is present in the water tank.
